(19) United States
(12) Patent Application Publication
(10) Pub. No.: US 2008/0234904 A1
(43) Pub. Date: Sep. 25, 2008

(54) CONTINUOUSLY VARIABLE TRANSMISSION SHIFT CONTROL SYSTEM AND CONTROL METHOD THEREOF

(75) Inventors: Masahiro Tawara, Toyota-shi (JP); Tadashi Tamura, Nishikamo-gun (JP); Akira Hino, Toyota-shi (JP); Shinya Toyoda, Nissin-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/050,505

(22) Filed: Mar. 18, 2008

(30) Foreign Application Priority Data
Mar. 23, 2007 (JP) 2007-076655

(51) Int. Cl. G06F 19/00

(52) U.S. Cl. 701/56

(57) ABSTRACT

A continuously variable transmission shift control system includes an input rotational speed monitoring unit that determines whether an actual input rotational speed of the CVT reaches the upper limit of a target input rotational speed, an acceleration request determining unit that determines whether a request for acceleration that is equal to or larger than a predetermined value is made, and a shift control inhibiting unit that inhibits shift control for reducing the target input rotational speed even when the actual input rotational speed reaches the upper limit of the target input rotational speed, in the case where the acceleration request determining unit determines that the request for acceleration that is equal to or larger than the predetermined value is made.

### INCORPORATION BY REFERENCE

The disclosure of Japanese Patent Application No. 2007-076655 filed on Mar. 23, 2007, including the specification, drawings and abstract, is incorporated herein by reference in its entirety.

### BACKGROUND OF THE INVENTION

1. Field of the Invention

This invention relates to continuously variable transmission shift control system and control method thereof, and in particular to continuously variable transmission shift control system and control method thereof which provide improved acceleration performance of a vehicle having a continuously variable transmission (which may be simply referred to as “CVT”).

2. Description of the Related Art

Generally, belt type continuously variable transmissions (CVT) are known. The belt type continuously variable transmission has a driving-side primary pulley having a V-shaped pulley groove, a driven-side secondary pulley having a V-shaped pulley groove, and a belt that engages the primary pulley and the secondary pulley and extends between these pulleys. By increasing the width of the pulley groove of one of the pulleys and reducing the width of the pulley groove of the other pulley at the same time, the radius (effective diameter) at which the belt engages each of the pulleys is continuously varied so that the gear ratio of the CVT is steplessly changed and set.

Torque transmitted through the belt type continuously variable transmission varies depending on the load that is applied in a direction in which the belt and each pulley contact with each other. Thus, the belt is sandwiched and gripped by the pulleys so that tension is applied to the belt.

As described above, the gear ratio of the CVT is changed by increasing and reducing the widths of the pulley grooves. More specifically, each pulley consists of a stationary sheave and a movable sheave, and a hydraulic actuator is provided on the back-face side of the movable sheave for moving the movable sheave back and forth in the axial direction so as to change the gear ratio.

In the continuously variable transmission as described above, the speed is increased when the pulley width of the primary pulley is reduced (the pulley radius is increased) while the pulley width of the secondary pulley is increased (the pulley radius is reduced) so that the rotational speed of the secondary pulley becomes higher than that of the primary pulley, and the speed is reduced when the pulley width of the primary pulley is increased (the pulley radius is reduced) and the pulley width of the secondary pulley is reduced (the pulley radius is increased) so that the rotational speed of the secondary pulley becomes lower than that of the primary pulley.

As a known example of shift control of the continuously variable transmission constructed as described above, a target input rotational speed NINT of the primary pulley is calculated based on the accelerator operation amount and the vehicle speed, and shift control is performed so that the actual input rotational speed NIN of the primary pulley becomes equal to the target input rotational speed NINT. Then, when the actual input rotational speed NIN of the primary pulley reaches the upper limit of the target input rotational speed NINT which is determined depending on the depression of the accelerator pedal, an upshift operation to reduce the target input rotational speed NINT is performed, as disclosed in, for example, Japanese Patent Application Publication No. 2004-125072 (JP-A-2004-125072).

In the shift control system for the continuously variable transmission as described above, the target input rotational speed NINT is reduced when the actual input rotational speed NIN of the primary pulley reaches the upper limit of the target input rotational speed NINT which depends on the depression of the accelerator pedal. When the driver makes a request for large acceleration, therefore, the vehicle having the CVT may not be able to provide sufficient driving force, and the driver's request for acceleration may not be satisfied.

### SUMMARY OF THE INVENTION

The invention provides continuously variable transmission shift control system and control method thereof that may prevent a shortage of driving force relative to the driver's request for acceleration, and may satisfy the driver's request for acceleration.

A continuously variable transmission shift control system according to a first aspect of the invention includes: a rotational speed control unit that sets a target input rotational speed of a continuously variable transmission connected to an internal combustion engine, based on operating conditions of a vehicle, and makes an actual input rotational speed of the continuously variable transmission equal to the target input rotational speed, an input rotational speed monitoring unit that determines whether the actual input rotational speed reaches an upper limit of the target input rotational speed, a shift control unit that performs shift control so as to reduce the target input rotational speed when the input rotational speed monitoring unit determines that the actual input rotational speed reaches the upper limit of the target input rotational speed, an acceleration request determining unit that determines whether a request for acceleration that is equal to or larger than a predetermined value is made, and a shift control inhibiting unit that inhibits shift control for reducing the target input rotational speed even when the actual input rotational speed reaches the upper limit of the target input rotational speed, in the case where the acceleration request determining unit determines that the request for acceleration that is equal to or larger than the predetermined value is made.

With the above arrangement, when the driver makes a request for large acceleration, shift control for reducing the target input rotational speed is not performed even when the actual input rotational speed reaches the upper limit of the target input rotational speed, and therefore the input rotational speed of the continuously variable transmission, namely, the rotational speed of the internal combustion engine, is prevented from being reduced. It is thus possible to prevent a shortage of driving force relative to the driver's request for acceleration, and satisfy the driver's request for acceleration.

A continuously variable transmission shift control method according to a second aspect of the invention includes: setting a target input rotational speed of a continuously variable transmission connected to an internal combustion engine, based on operating conditions of a vehicle, performing control so as to make an actual input rotational speed of the continuously variable transmission equal to the target input rotational speed, performing shift control so as to reduce the target input rotational speed when the actual input rotational speed reaches an upper limit of the target input rotational speed, determining whether a request for acceleration that is equal to or larger than a predetermined value is made, and inhibiting shift control for reducing the target input rotational speed even when the actual input rotational speed reaches the upper limit of the target input rotational speed, if it is determined that the request for acceleration that is equal to or larger than the predetermined value is made.

The present invention may provide continuously variable transmission shift control system and shift control method that may prevent a shortage of driving force relative to the driver's request for acceleration, and may satisfy the driver's request for acceleration.

### BRIEF DESCRIPTION OF THE DRAWINGS

The foregoing and/or further objects, features and advantages of the invention will become more apparent from the following description of a preferred embodiment of the invention with reference to the accompanying drawings, in which like numerals are used to represent like elements and wherein:

FIG. 1 is a schematic view showing the construction of a vehicular power transmitting system including a continuously variable transmission, to which a continuously variable transmission shift control system according to one embodiment of the invention is applied;

FIG. 2 is a view showing a portion of a hydraulic control circuit which is associated with belt tension control, in the continuously variable transmission shift control system according to the embodiment of the invention;

FIG. 3 is a view showing a portion of the hydraulic control circuit which is associated with gear ratio control, in the continuously variable transmission shift control system according to the embodiment of the invention;

FIG. 4 is a view showing the configuration of the continuously variable transmission shift control system according to the embodiment of the invention;

FIG. 5 is a view showing a shift map used in the continuously variable transmission shift control system according to the embodiment of the invention;

FIG. 6 is a timing chart showing changes in the target input rotational speed and actual input rotational speed in the continuously variable transmission shift control system according to the embodiment of the invention; and

FIG. 7 is a view showing a flowchart of a shift control process performed by the continuously variable transmission shift control system according to the embodiment of the invention.

### DETAILED DESCRIPTION OF THE EMBODIMENT

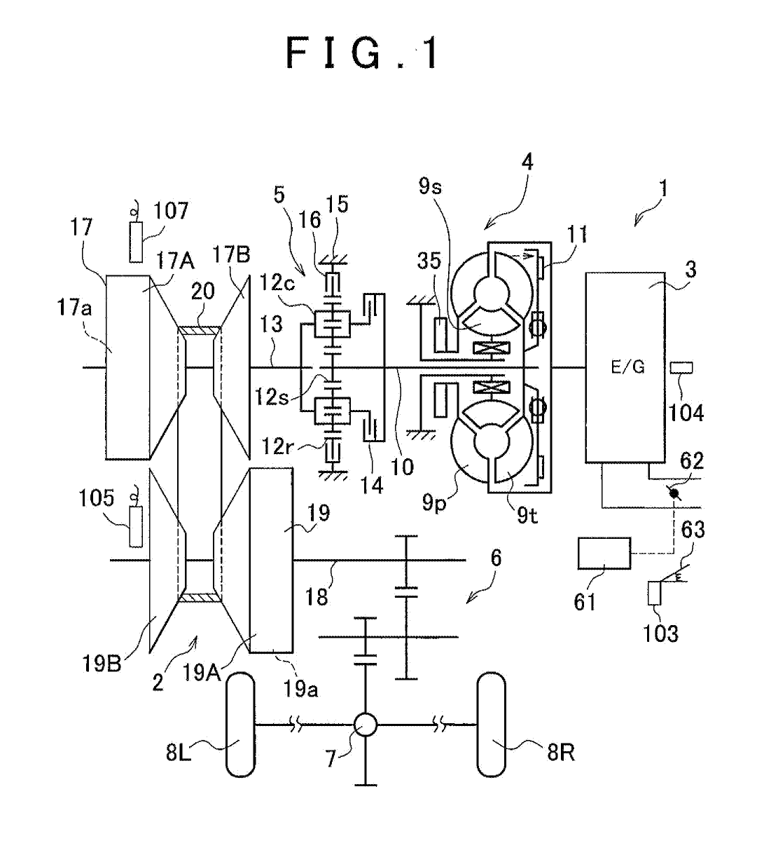

A continuously variable transmission shift control system as one embodiment of the invention will be described with reference to FIG. 1 through FIG. 7. Initially, the construction of the vehicle on which the continuously variable transmission shift control system is installed will be described. In FIG. 1, a power transmitting system 1 provided in the vehicle and including a belt type continuously variable transmission 2 is favorably employed in, for example, a transverse FF (front-engine, front-drive) vehicle, and is provided with an engine 3 as an internal combustion engine.

The power of the engine 3 is transmitted to a differential gear unit 7 via a torque converter 4, a forward/reverse drive switching device 5, a belt type continuously variable transmission (hereinafter simply referred to as “CVT”) 2, and reduction gears 6, and is distributed to right and left driving wheels 8R, 8L. Thus, the CVT 2 is mounted in a power transmission path that extends from the engine 3 to the right and left driving wheels (e.g., front wheels) 8R, 8L.

The torque converter 4 includes a pump impeller 9p coupled to the crankshaft of the engine 3, a turbine wheel 9t coupled to the forward/reverse drive switching device 5 via a turbine shaft 10, and a stator 9s that is rotatably supported by a stationary member via a one-way clutch, and is operable to transmit power via fluid.

Between the pump impeller 9p and the turbine wheel 9t, there is provided a lock-up clutch 11 that directly couples the pump impeller 9p and the turbine wheel 9t with each other so that the pump impeller 9p and the turbine wheel 9t may rotate as a unit.

The forward/reverse drive switching device 5 consists of a double-pinion type planetary gear set, and has a sun gear 12s to which the turbine shaft 10 of the torque converter 4 is coupled, a carrier 12c to which an input shaft 13 of the CVT 2 is coupled, and a ring gear 12r.

When a forward-drive clutch 14 disposed between the carrier 12c and the sun gear 12s is engaged, the forward/reverse drive switching device 5 is rotated as a unit, and the turbine shaft 10 is directly coupled to the input shaft 13, so that driving force for running the vehicle forward is transmitted to the driving wheels 8L, 8R.

When a reverse brake 16 provided between the ring gear 12r and a housing 15 is engaged, and the forward-drive clutch 14 is released, the input shaft 13 is rotated in the direction opposite to that of rotation of the turbine shaft 10, and driving force for running the vehicle backward is transmitted to the driving wheels 8L, 8R.

The CVT 2 includes a primary pulley 17 provided on the input shaft 13, a secondary pulley 19 provided on an output shaft 18, and a transmission belt 20 that extends from a V-shaped groove formed in the primary pulley 17 to a V-shaped groove formed in the secondary pulley 19 to be engaged in these grooves. The effective diameters of the primary and secondary pulleys 17, 19 are variable. In operation, power is transmitted to the transmission belt 20 serving as a power transmitting member, by use of friction between the belt 20 and the inner wall of each of the V-shaped grooves of the primary pulley 17 and secondary pulley 19.

More specifically, the primary pulley 17 includes movable sheave 17A and stationary sheave 17B having mutually opposed faces that form the V-shaped groove, and the transmission belt 20 engages the V-shaped groove formed between the movable sheave 17A and the stationary sheave 17B.

Similarly, the secondary pulley 19 includes movable sheave 19A and stationary sheave 19B having mutually opposed faces that form the V-shaped groove, and the transmission belt 20 engages the V-shaped groove formed between the movable sheave 19A and the stationary sheave 19B.

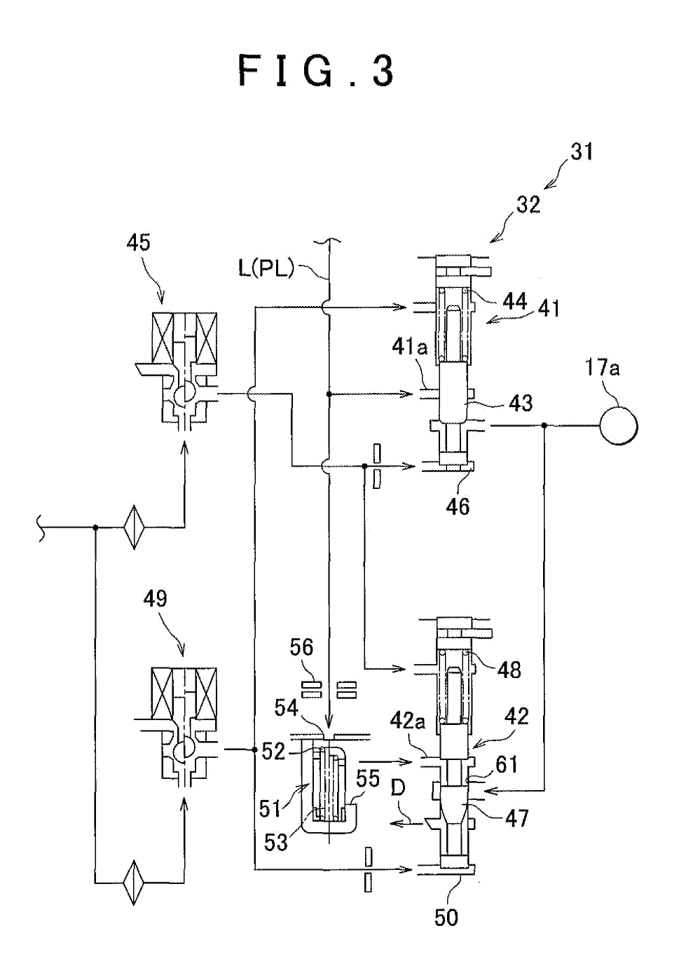

The primary pulley 17 includes an input-side hydraulic cylinder 17a formed in the movable sheave 17A, and the secondary pulley 19 includes an output-side hydraulic cylinder 19a formed in the movable sheave 19A. Each of the input-side hydraulic cylinder 17a and output-side hydraulic cylinder 19a is operable to change the width of the V-shaped groove (hereinafter referred to as “V-groove width”), or the pulley radius at which the transmission belt 20 engages the corresponding pulley 17, 19. The amount of hydraulic fluid supplied to or discharged from the input-side hydraulic cylinder 17a of the movable sheave 17A is controlled by a shift control valve device 32 in a hydraulic control circuit 31 (see FIG. 3), so that the V-groove widths of the primary pulley 17 and secondary pulley 19 are changed, and the pulley radii at which the transmission belt 20 engages the pulleys (i.e., effective diameters of the pulleys 17, 19) are changed. As a result, the gear ratio γ (=the actual input rotational speed NIN/the actual output rotational speed NOUT) is continuously changed. In this embodiment, NIN represents the actual rotational speed of the primary pulley 17, and NOUT represents the actual rotational speed of the secondary pulley 19. Also, NINT represents a target input rotational speed of the primary pulley 17, which will be described in detail later.

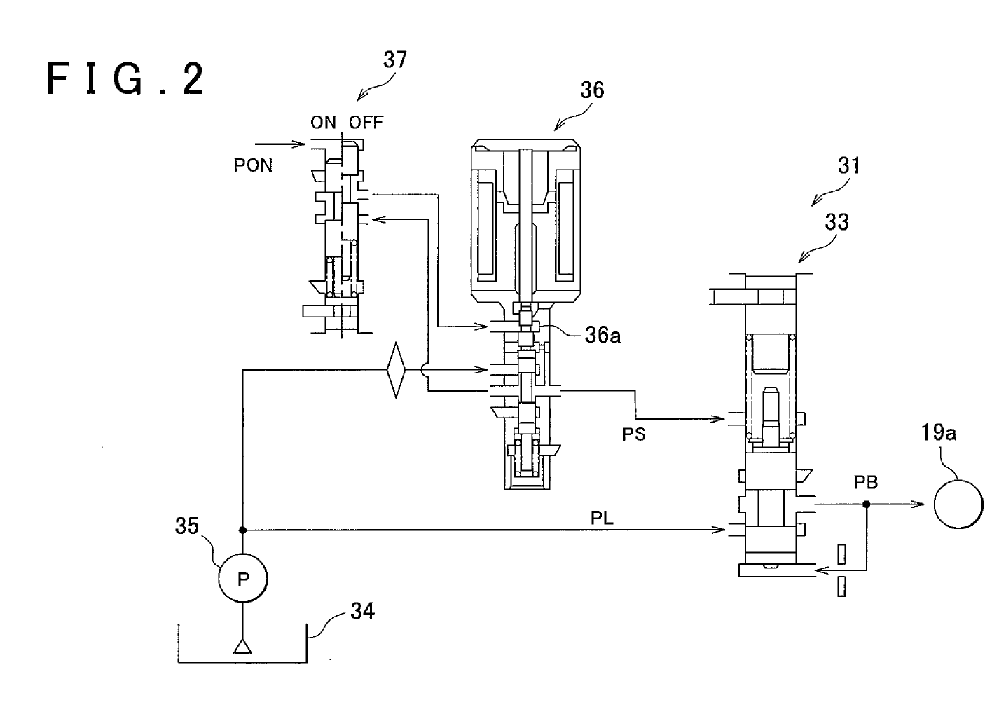

The hydraulic pressure PB in the output-side hydraulic cylinder 19a of the movable sheave 19A corresponds to the grip force applied from the secondary pulley 19 to the transmission belt 20 and the tension of the transmission belt 20, and is closely related with the tension of the transmission belt 20, namely, the force with which the transmission belt 20 presses the inner walls of the V-shaped grooves of the primary pulley 17 and secondary pulley 19. Thus, the hydraulic pressure PB may also be called “belt tension control pressure” or “belt grip force control pressure” or “belt pressing force control pressure”. The hydraulic pressure PB is regulated by a grip force control valve 33 (see FIG. 2) in the hydraulic control circuit 31, so as to prevent the transmission belt 20 from slipping.

FIG. 2 and FIG. 3 illustrate one example of hydraulic control circuit 31. FIG. 2 shows a circuit associated with the operation to regulate the belt tension control pressure, and FIG. 3 shows a circuit associated with gear ratio control. In FIG. 2, the hydraulic fluid that returns to an oil tank 34 is pumped up and fed under pressure by, for example, a gear type hydraulic pump 35 that is directly coupled to the engine 3 and rotated or driven by the engine 3, and the pressure of the hydraulic fluid is regulated into a line pressure PL by a line-pressure regulating valve (not shown). The line pressure PL is then supplied as the original pressure to a linear solenoid valve 36 and the above-mentioned grip force control valve 33.

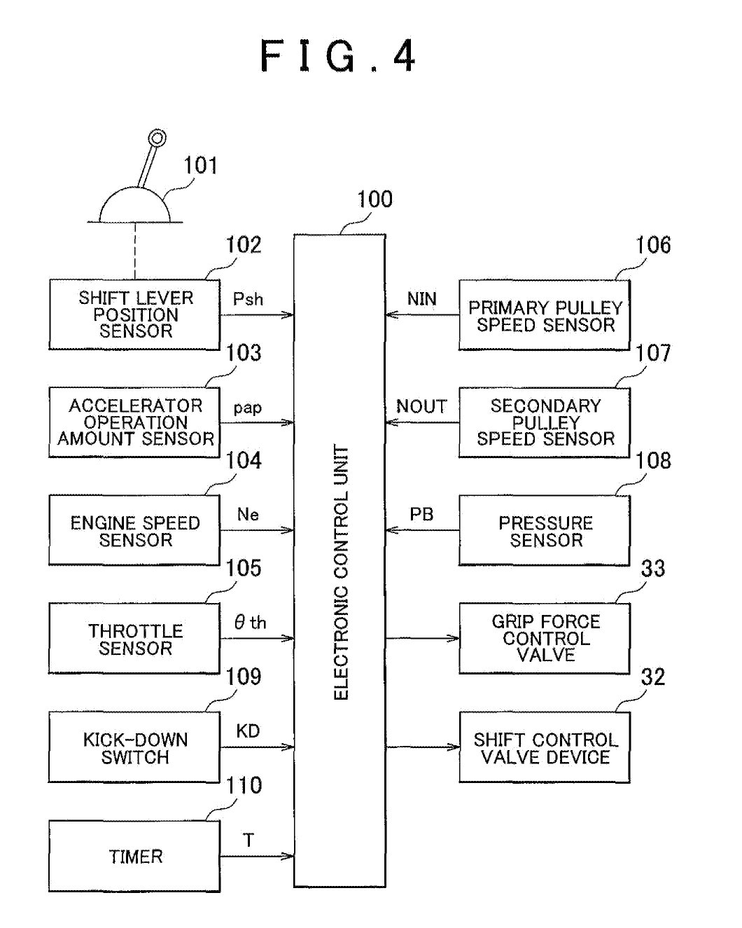

The linear solenoid valve 36 is continuously controlled by exciting current generated from an electronic control unit 100 (see FIG. 4), so as to produce a control pressure PS whose magnitude is commensurate with the exciting current, from the oil pressure of the hydraulic fluid supplied from the hydraulic pump 35, and supply the control pressure PS to the grip force control valve 33.

The grip force control valve 33 produces an oil pressure PB that increases as the control pressure PS increases, and supplies the oil pressure PB to the output-side hydraulic cylinder 19a of the movable sheave 19, so that the grip force applied to the transmission belt 20, namely, the tension of the transmission belt 20, is reduced as much as possible within a range in which slip of the transmission belt 20 does not occur. As the oil pressure PB increases, the belt grip force, i.e., the friction between the primary pulley 17 and secondary pulley 19, and the transmission belt 20, is increased.

The linear solenoid valve 36 has an oil chamber 36a to which the control pressure PS is supplied from a cut-back valve 37 when the valve 37 is ON. When the cut-back valve 37 is OFF, on the other hand, supply of the control pressure PS to the oil chamber 36a of the linear solenoid valve 36 is interrupted or inhibited, and the oil chamber 36a is held open to the atmosphere. With this arrangement, the control pressure PS is switched to a lower level when the cut-back valve 37 is ON, than the control pressure PS developed when the cut-back valve 37 is OFF.

When the lock-up clutch 11 of the torque converter 4 is ON (engaged), the cut-back valve 37 receives a signal pressure PON from an electromagnetic valve (not shown), and is switched to ON.

In FIG. 3, the shift control valve device 32 is constructed of an upshift control valve 41 and a downshift control valve 42. The upshift control valve 41 supplies the hydraulic fluid having the line pressure PL exclusively to the input-side hydraulic cylinder 17a of the movable sheave 17A, and controls the amount or flow rate of the hydraulic fluid thus supplied so as to control the speed at which the gear ratio is changed in the upshift direction. The downshift control valve 42 controls the amount or flow rate of the hydraulic fluid discharged from the input-side hydraulic cylinder 17a of the movable sheave 17A, so as to control the speed at which the gear ratio is changed in the downshift direction.

The upshift control valve 41 has an input port 41a that communicates with a line oil path L through which the line pressure PL is fed. The upshift control valve 41 includes a spool valve 43 that is selectively placed in the open position in which the line oil path L communicates with the input-side hydraulic cylinder 17a, and the closed position in which the line oil path L is disconnected from the hydraulic cylinder 17a, a spring 44 that biases the spool valve 43 in the valve-closing direction, and a control oil chamber 46 that receives a control pressure from an upshift-side electromagnetic valve 45.

The downshift control valve 42 includes a spool valve 47 that is selectively placed in the open position in which a drain oil path D communicates with the input-side hydraulic cylinder 17a, and the closed position in which the drain oil path D is disconnected from the hydraulic cylinder 17a, a spring 48 that biases the spool valve 47 in the valve-closing direction, and a control oil chamber 50 that receives a control pressure from a downshift-side electromagnetic valve 49.

The upshift-side electromagnetic valve 45 and the downshift-side electromagnetic valve 49 are duty-driven by the electronic control unit 100, so as to supply continuously varying control pressures to the control oil chamber 46 and control oil chamber 50, respectively, and continuously change the gear ratio γ of the CVT 2 to the upshift side (i.e., to a smaller gear ratio) or to the downshift side (i.e., to a larger gear ratio).

Also, a pressure regulating valve 51 is connected to an input port 42a of the downshift control valve 42. The pressure regulating valve 51 has an input port 54 that is formed on the front side of a piston 52 pressed by a spring 53 and receives the line pressure PL, and an output port 55 that communicates with the front side and back side of the piston 52. The output port 55 communicates with an input port 42a of the downshift control valve 42.

The line pressure PL is supplied to the input port 54 of the pressure regulating valve 51 via a double orifice 56 having a small opening area. Namely, the pressure regulating valve 51 regulates the line pressure PL into a hydraulic pressure that is reduced from the line pressure PL by the amount corresponding to the elastic force of the spring 53, so that the thus regulated line pressure PL appears in the output port 55, i.e., in the input port 42a of the downshift control valve 42.

FIG. 4 shows the electronic control unit 100 provided in the vehicle of this embodiment. To the electronic control unit 100 are connected a shift lever position sensor 102, accelerator operation amount sensor 103, engine speed sensor 104, throttle sensor 105, primary pulley speed sensor 106, secondary pulley speed sensor 107, pressure sensor 108, kick-down switch 109, timer 110, the grip force control valve 33 and the shift control valve device 32.

The shift lever position sensor 102 detects the position Psh to which a shift lever 101 provided in the vehicle compartment is operated, and transmits a signal indicative of the lever position Psh to the electronic control unit 100.

The accelerator operation amount sensor 103 detects the amount of operation pap of the accelerator pedal 63 (see FIG. 1) (which will be called “accelerator operation amount pap”), and transmits a signal indicative of the accelerator operation amount pap to the electronic control unit 100 as a signal that reflects the driver's request for acceleration.

The engine speed sensor 104 detects the rotational speed Ne of the engine 3, and transmits a signal indicative of the engine speed Ne to the electronic control unit 100. More specifically, the engine speed sensor 104 detects the number of revolutions of the crankshaft of the engine 3 per unit time.

The throttle sensor 105 detects the degree of opening θth of a throttle valve 62 (see FIG. 1) that is driven by a throttle actuator 61 (which will be simply called “throttle opening θth”), and transmits a signal indicative of the throttle opening θth to the electronic control unit 100.

The primary pulley speed sensor 106 detects the actual rotational speed NIN of the input shaft 13 of the primary pulley 17, and transmits a signal indicative of the actual input rotational speed NIN of the primary pulley 17 to the electronic control unit 100. The actual input rotational speed NIN of the primary pulley 17 is the same speed as the rotational speed of the engine 3.

The secondary pulley speed sensor 107 detects the rotational speed of the output shaft 18 of the secondary pulley 19, and transmits a signal indicative of the actual output rotational speed NOUT of the secondary pulley 19 to the electronic control unit 100. The electronic control unit 100 determines the vehicle speed based on the actual rotational speed NOUT received from the secondary pulley speed sensor 107.

The pressure sensor 108 detects the pressure inside the output-side hydraulic cylinder 19a of the movable sheave 19A of the secondary pulley 19, namely, the actual belt grip force control pressure, and transmits a hydraulic pressure signal PB to the electronic control unit 100.

The kick-down switch 109, which is mounted on the floor at the back side of the accelerator pedal 63, is turned ON when the accelerator pedal 63 is largely depressed, for example, when the accelerator operation amount becomes 100%, and transmits a kick-down signal KD to the electronic control unit 100.

The timer 110 measures time from a point in time at which the kick-down switch 109 is turned OFF, namely, starts measuring time when the kick-down switch 109 is turned OFF.

The electronic control unit 100 includes a microcomputer that consists principally of CPU (central processing unit), ROM (read only memory), RAM (random access memory), input and output interfaces, and so forth. The electronic control unit 100 performs signal processing according to a shift control program stored in advance in the ROM, utilizing the temporary storage function of the RAM, and thus performs shift control of the CVT 2 so as to provide a favorable sense of acceleration and improved fuel economy.

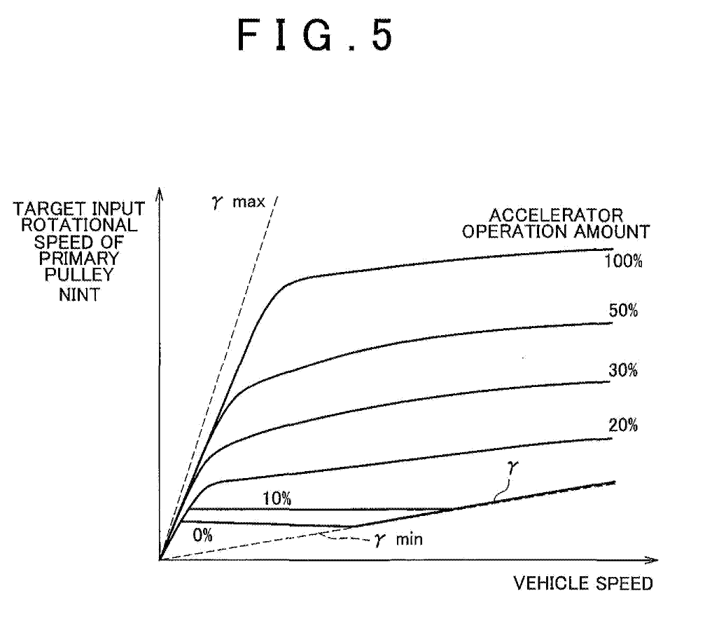

The shift control performed on the CVT 2 will be described with reference to a shift map as shown in FIG. 5. In the shift map shown in FIG. 5, the horizontal axis indicates the vehicle speed, and the vertical axis indicates the target input rotational speed NINT of the primary pulley 17, while the accelerator operation amount is used as a parameter. This map is stored in the ROM of the electronic control unit 100.

As shown in FIG. 5, the relationship between the vehicle speed and the target input rotational speed NINT (target value) of the primary pulley 17 for each accelerator operation amount as a parameter is specified, within a range from the minimum gear ratio (γmin) of the CVT 2 to the maximum gear ratio (γmax).

To plot the shift map of FIG. 5, a target engine power needed or desired by the driver is determined from the accelerator operation amount and the vehicle speed, and the target input rotational speed NINT of the primary pulley 17 is determined so that the thus determined target engine power may be achieved or realized on the optimum fuel economy line. The gear ratio is set to vary from the minimum state to the maximum state as the accelerator operation amount increases.

In the shift control of the CVT 2, the target input rotational speed NINT of the primary pulley 17 is set based on the accelerator operation amount and the vehicle speed, so as to achieve the optimum gear ratio and the optimum rate of change of the gear ratio.

The electronic control unit 100 transmits control signals to the shift control valve device 32 and the grip force control valve 33 so that the actual input rotational speed NIN received from the primary pulley speed sensor 106 becomes equal to the target input rotational speed NINT of the primary pulley 17, for optimization of the gear ratio. Thus, the electronic control unit 100 controls the shift control valve device 32 and the grip force control valve 33 so that the actual input rotational speed NIN received from the primary pulley speed sensor 106 coincides with the target input rotational speed NINT.

The electronic control unit 100 then determines whether the target input rotational speed NINT reaches its upper limit. When the electronic control unit 100 determines that the actual input rotational speed NIN of the primary pulley 17 reaches the upper limit of the target input rotational speed NINT, it performs an upshift operation to reduce the target input rotational speed NINT.

Then, control is performed so as to make the actual input rotational speed NIN of the primary pulley 17 equal to the target input rotational speed NINT set after upshifting, and another upshift operation to reduce the target input rotational speed NINT is performed when it is determined that the actual input rotational speed NIN becomes equal to the target input rotational speed NINT. By repeating the control as described above, the vehicle speed is continuously increased. The electronic control unit 100 increments a counter, i.e., adds “1” to the counter value, each time the actual input rotational speed NIN reaches the upper limit of the target input rotational speed NINT, and stores the counter value in a storage region of the RAM.

The target input rotational speed NINT is set so as to increase as the vehicle speed increases after upshifting, and the actual input rotational speed NIN is controlled so as to increase to be equal to the target input rotational speed NINT. Thus, the rotational speed of the primary pulley 17 increases in proportion to the rotational speed of the engine 3.

The electronic control unit 100 determines a request of the driver for acceleration, based on the accelerator operation amount received from the accelerator operation amount sensor 103, and determines that the driver makes a request for acceleration that is equal to or larger than a predetermined value when it receives a kick-down signal KD from the kick-down switch 109. In this embodiment, the electronic control unit 100 and the kick-down switch 109 function as the acceleration request determining unit of the invention.

When the electronic control unit 100 receives the kick-down signal KD from the kick-down switch 109, the control unit 100 inhibits an upshift operation, i.e., shift control for reducing the target input rotational speed NINT, even when the actual input rotational speed NIN reaches the upper limit of the target input rotational speed NINT, and makes a correction to increase the target input rotational speed NINT by a predetermined speed.

When the kick-down switch 109 is switched from ON to OFF upon completion of the lick-down operation, the electronic control unit 100 sets the target input rotational speed NINT again from the accelerator operation amount pap and the vehicle speed, based on the shift map shown in FIG. 5. At the same time, the electronic control unit 100 resets the counter value stored in the storage region of the RAM.

More specifically, the electronic control unit 100 resets the target input rotational speed NINT that has been set to a low value each time an upshift operation is performed, at a point in time when the kick-down switch 109 is turned ON. The control unit 100 then determines the target engine power needed or desired by the driver again, from the accelerator operation amount pap and the vehicle speed, based on the shift map shown in FIG. 5, and sets the target input rotational speed NINT of the primary pulley 17 so that the target engine power thus determined may be achieved or realized on the optimum fuel economy line of the engine 3.

Also, the electronic control unit 100 actuates the timer 110 (i.e., starts measuring time with the timer 110) when the kick down switch 109 is switched from ON to OFF upon completion of the kick-down operation, and inhibits the target input rotational speed NINT from being reduced until the time measured by the timer 110 reaches a predetermined time T. Thus, upshift of the CVT 2 (reduction of the gear ratio) and reduction of the target input rotational speed NINT are inhibited immediately after the kick-down switch 109 is turned OFF.

In this embodiment, the electronic control unit 100 functions as the rotational speed control unit, the shift control unit, the input rotational speed monitoring unit, the shift control inhibiting unit and the counting control unit of the invention. Also, the electronic control unit 100 causes the timer 110 to measure time, and determines whether the measured time reaches the predetermined time T.

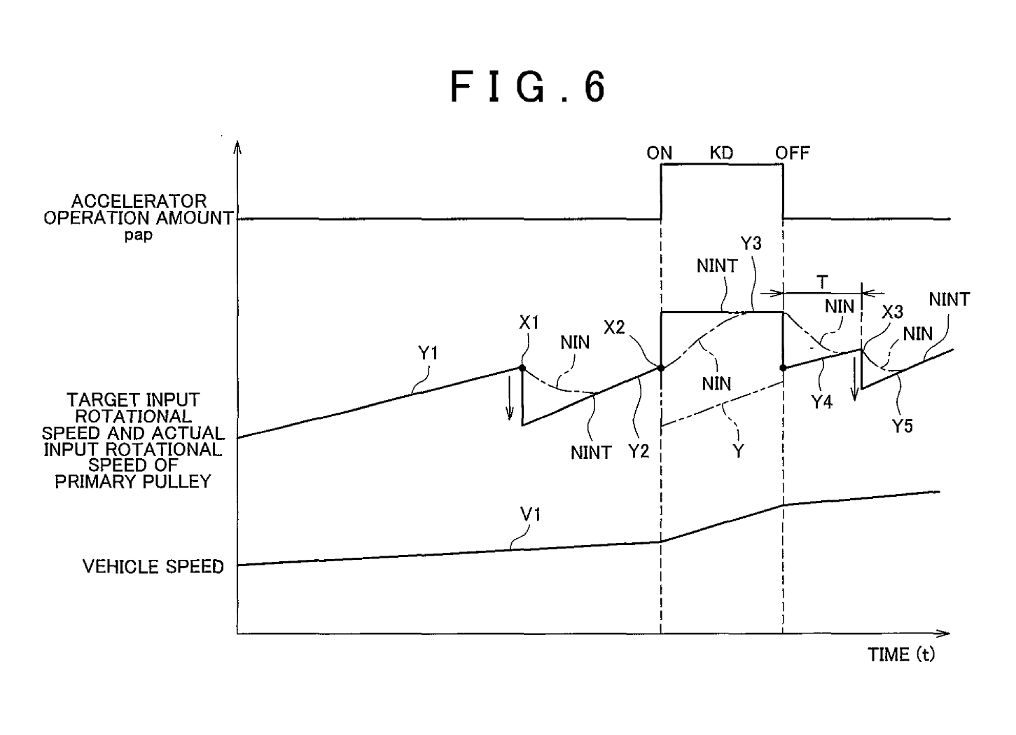

Next, the shift control process of this embodiment will be described with reference to the timing chart of FIG. 6 showing changes in the target input rotational speed NINT and actual input rotational speed NIN of the primary pulley 17 during acceleration of the vehicle. In this embodiment, the CPU of the electronic control unit 100 determines a target engine power desired by the driver, from the accelerator operation amount pap and the vehicle speed, based on the shift map of FIG. 5 stored in the ROM, and sets a target input rotational speed NINT of the primary pulley 17 so that the determined target engine power may be achieved or realized on the optimum fuel economy line of the engine 3.

The target input rotational speed NINT is set so as to increase as the vehicle speed increases, as indicated by solid lines Y1, Y2 in FIG. 6, and linear shift control is performed under which the actual input rotational speed NIN of the primary pulley 17 increases from the time when the accelerator pedal 63 is depressed, so that the actual input rotational speed NIN becomes equal to the target input rotational speed NINT.

When the actual input rotational speed NIN reaches the upper limit of the target input rotational speed NINT, as indicated by X1 in FIG. 6, an upshift operation to reduce the target input rotational speed NINT is performed based on the shift map. At this time, the counter value stored in the storage region of the RAM is incremented, i.e., is increased by 1.

When shift control for reducing the target input rotational speed NINT of the primary pulley 17 is performed, the target input rotational speed NINT is set so as to increase as the vehicle speed increases, as indicated by solid line Y2 in FIG. 6. Thus, after the accelerator pedal 63 is depressed, linear shift control is performed under which the actual input rotational speed NIN of the primary pulley 17 increases to be equal to the target input rotational speed NINT.

When the actual input rotational speed NIN reaches the upper limit of the target input rotational speed NINT, an upshift operation to reduce the target input rotational speed NINT is performed. Also, the counter value stored in the storage region of the RAM is incremented. In this embodiment, the upshift operation (reduction of the gear ratio) is repeatedly performed so that the vehicle speed is continuously increased.

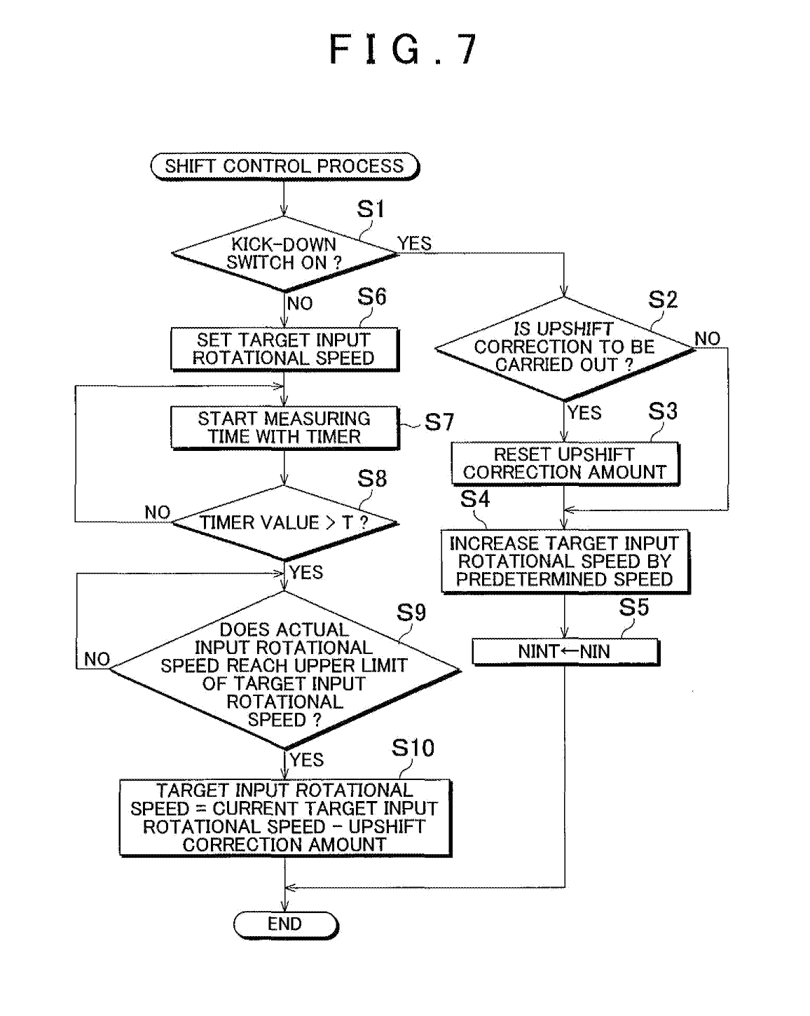

The present embodiment is characterized in shift control performed when the kick-down switch 109 is turned ON during linear shift control. The shift control process performed when the kick-down switch 109 is turned ON will be explained with reference to the flowchart of FIG. 7. The flowchart of FIG. 7 is a shift control program stored in the ROM of the electronic control unit 100, and the shift control program is implemented by the CPU.

Initially, the CPU of the electronic control unit 100 determines whether the kick-down switch 109 is turned ON (step S1). If the kick-down switch 109 is turned ON, the CPU determines whether an upshift correction is to be carried out (step S2). Namely, it is determined whether the actual input rotational speed NIN reaches the upper limit of the target input rotational speed NINT.

If it is determined in step S2 that the actual input rotational speed NIN has not reached the upper limit of the target input rotational speed NINT, namely, if the kick-down switch 109 is turned ON before the actual input rotational speed NIN reaches the upper limit of the target input rotational speed NINT, the CPU proceeds to step S4.

In step S4, the target input rotational speed NINT is increased by a predetermined speed, and the actual input rotational speed NIN is increased so as to coincide with the target input rotational speed NINT (step S5).

If it is determined in step S2 that the actual input rotational speed NIN reaches the upper limit of the target input rotational speed NINT, namely, if it is determined that the actual input rotational speed NIN reaches point X2 in FIG. 6, an upshift operation is inhibited from being performed. More specifically, the amount of correction of the target input rotational speed NINT that would be required for upshifting is reset (step S3), and the target input rotational speed NINT is inhibited from being reduced as indicated by virtual line (two-dot chain line) Y in FIG. 6. Then, the target input rotational speed NINT is increased by a predetermined speed (step S4). Namely, when the kick-down switch 109 is turned ON, the target input rotational speed NINT is set to be higher, as indicated by solid line Y3, than the target input rotational speed NINT as indicated by solid line Y2 where the kick-down switch 109 is not turned ON, even under the same operating conditions of the vehicle, for example, at the same vehicle speed.

Subsequently, the actual input rotational speed NIN is increased so as to coincide with the target input rotational speed NINT (step S5). If it is determined in step S1 that the kick-down switch 109 is switched from ON to OFF, the target input rotational speed NINT of the primary pulley 17 is set again based on the shift map as shown in FIG. 5 (step S6).

Namely, since the input rotational speed of the primary pulley 17 is kept reduced through repeated upshift operations, as indicated by solid lines Y1, Y2, the target input rotational speed NINT set before the kick-down switch 109 is turned ON is reset on the occasion that the kick-down switch 109 is turned ON. More specifically, the counter value stored in the storage region of the RAM is reset, and the target input rotational speed NINT is set again based on the operating conditions, such as the vehicle speed and the accelerator operation amount pap, of the vehicle at the time when the kick-down switch 109 is turned OFF. Needless to say, the target input rotational speed NINT at the time when the kick-down switch 109 is turned OFF is higher, as indicated by solid line Y4 in FIG. 6, than the target input rotational NINT at the time when the kick-down switch 109 is turned ON (but actually not turned ON).

Thus, in step S6, the target input rotational speed NINT at the time when the kick-down switch 109 is turned OFF is set to be higher than the target input rotational speed NINT at the time when the kick down switch 109 is turned ON (but actually not turned ON), based on the shift map.

Then, the CPU actuates the timer 110 to start measuring time, to provide measured time information (step S7), and then determines whether the measured time received from the timer 110 reaches a predetermined time T (step S8). The predetermined time T is set to 3 to 5 seconds.

When the time measured by the timer 110 reaches the predetermined time T, it is determined whether the actual input rotational speed NIN reaches the upper limit of the target input rotational speed NINT (step S9). If it is determined in step S9 that the actual input rotational speed NIN reaches the upper limit of the target input rotational speed NINT, as indicated by X3 in FIG. 6, an upshift correction amount (the amount by which the target input rotational speed NINT is corrected) for upshifting from the current target input rotational speed NINT is calculated, based on the shift map of FIG. 5, and an upshift operation to reduce the target input rotational speed NINT by the upshift correction amount is performed. Then, control is performed until the actual input rotational speed NIN becomes equal to the target input rotational speed NINT as indicated by solid line Y5 in FIG. 6.

Namely, in step S7 through step S9, upshifting is inhibited for the predetermined time T after the kick-down switch 109 is turned OFF, so that upshifting is prevented from being effected immediately after the kick-down switch 109 is turned OFF even in the case where the actual input rotational speed NIN reaches the upper limit of the target input rotational speed NINT immediately after the kick-down switch 109 is turned OFF.

Thus, in the present embodiment, when the kick-down switch 109 is turned ON, an upshift operation to reduce the target input rotational speed NINT is not performed even when the actual input rotational speed NIN reaches the upper limit of the target input rotational speed NINT, and therefore the input rotational speed of the primary pulley 17 is prevented from being reduced. It is thus possible to prevent a shortage of driving force relative to the driver's request for acceleration, and satisfy the driver's request for acceleration.

Also, in this embodiment, the target input rotational speed NINT is set again based on the operating conditions of the vehicle when the kick-down switch 109 is switched from ON to OFF, and therefore the input rotational speed of the primary pulley 17 is prevented from being kept reduced.

More specifically, when the kick-down switch 109 is turned OFF, the target input rotational speed is set again based on the operating conditions of the vehicle, namely, the counter value is reset and the target input rotational speed is set to a high speed. In this manner, the target input rotational speed NINT is prevented from being set to a further reduced value when the kick-down switch 109 is switched from ON to OFF, and the input rotational speed of the primary pulley 17 is prevented from being kept reduced.

In the this embodiment, when the kick down switch 109 is turned ON, the target input rotational speed NINT is set to a higher speed (as indicated by solid line Y3 is FIG. 6) than that in the case where the kick-down switch 109 is OFF at the same vehicle speed. By setting the input rotational speed of the primary pulley 17 to a high speed, it is possible to prevent a shortage of driving force relative to the driver's request for acceleration, and satisfy the driver's request for acceleration.

Also, in the present embodiment, the target input rotational speed NINT is inhibited from being reduced for the predetermined time T after the kick-down switch 109 is switched from ON to OFF, so that the target input rotational speed NINT is prevented from suddenly reduced immediately after the kick-down switch 109 is turned OFF. It is thus possible to prevent the input rotational speed of the primary pulley 17 from being suddenly reduced, and prevent the driver from feeling uncomfortable about the sudden reduction of the input rotational speed.

Also, in the present embodiment, linear shift control is performed under which the target input rotational speed NINT is increased as the vehicle speed increases after the accelerator pedal 63 is depressed, so that the actual input rotational speed NIN of the primary pulley 17 may be increased as the vehicle speed increases. Therefore, the vehicle may be smoothly accelerated, thus assuring improved driveability.

Also, in the present embodiment, the electronic control unit 100 determines, by means of the kick-down switch 109, whether accelerator operation amount becomes equal to a predetermined value, and determines that the acceleration requested by the driver is equal to or larger than a predetermined value when the kick-down switch 109 is ON. Thus, shift control for reducing the target input rotational speed may be inhibited when a considerably large accelerator operation amount is reached, and the kick-down switch 109 is turned ON, so as to prevent a shortage of driving force relative to the driver's request for considerably large acceleration, and satisfy the driver's request for acceleration.

While the kick-down switch 109 serves as a means for determining the driver's request for acceleration, namely, it is determined that the driver makes a request for large acceleration when the kick-down switch 109 is turned ON, the invention is not limited to this arrangement. For example, it may be determined that the driver makes a request for large acceleration when the amount of operation (or travel) pap of the accelerator pedal 63, which is measured by the accelerator operation amount sensor 103, becomes equal to or larger than a predetermined amount, for example, equal to or larger than 65%. It may also be determined that the driver makes a request for large acceleration when the degree of opening θth of the throttle valve 62, which is detected by the throttle sensor 105, is equal to or greater than 95%.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

As described above, the continuously variable transmission shift control system according to the invention is able to prevent a shortage of driving force relative to the driver's request for acceleration, and satisfy the driver's request for acceleration, thus assuring improved acceleration performance of the vehicle including the continuously variable transmission.

What is claimed is:

1. A continuously variable transmission shift control system, comprising:
a rotational speed control unit that sets a target input rotational speed of a continuously variable transmission connected to an internal combustion engine, based on operating conditions of a vehicle, and makes an actual input rotational speed of the continuously variable transmission equal to the target input rotational speed;
an input rotational speed monitoring unit that determines whether the actual input rotational speed reaches an upper limit of the target input rotational speed;
a shift control unit that performs shift control so as to reduce the target input rotational speed when the input rotational speed monitoring unit determines that the actual input rotational speed reaches the upper limit of the target input rotational speed;
an acceleration request determining unit that determines whether a request for acceleration that is equal to or larger than a predetermined value is made; and
a shift control inhibiting unit that inhibits shift control for reducing the target input rotational speed even when the actual input rotational speed reaches the upper limit of the target input rotational speed, in the case where the acceleration request determining unit determines that the request for acceleration that is equal to or larger than the predetermined value is made.

2. The continuously variable transmission shift control system according to claim 1, wherein the shift control inhibiting unit inhibits shift control for reducing the target input rotational speed while the request for acceleration that is equal to or larger than the predetermined value is being made.

3. The continuously variable transmission shift control system according to claim 1, wherein the shift control inhibiting unit sets the target input rotational speed again based on the operating conditions of the vehicle when the request for acceleration that has been equal to or larger than the predetermined value becomes smaller than the predetermined value.

4. The continuously variable transmission shift control system according to claim 3, wherein the shift control inhibiting unit sets the target input rotational speed again, based on a shift map which contains the information of indicating relationships between a vehicle speed and the target input rotational speed with respect to a plurality of accelerator operation amount accelerator operation amount, when the request for acceleration that has been equal to or larger than the predetermined value becomes smaller than the predetermined value.

5. The continuously variable transmission shift control system according to claim 3, wherein the shift control inhibiting unit sets again a maximum value of the target input rotational speed after the request for acceleration that has been equal to or larger than the predetermined value becomes smaller than the predetermined value, to be higher than that of the target input rotational speed before the request for acceleration that is equal to or larger than the predetermined value is made.

6. The continuously variable transmission shift control system according to claim 5, further comprising a counting control unit that increments a counter value representing the number of times of shift control that is performed so as to reduce the target input rotational speed,
wherein the counting control unit resets the counter value to zero when it is determined that the request for acceleration that is equal to or larger than the predetermined value is made.

7. The continuously variable transmission shift control system according to claim 1, wherein when the request for acceleration that is equal to or larger than the predetermined value is made, the shift control inhibiting unit sets the target input rotational speed to be higher than that in the case where a request for acceleration that is smaller than the predetermined value is made.

8. The continuously variable transmission shift control system according to claim 7, wherein even in a condition where the actual input rotational speed has not reached the upper limit of the target input rotational speed, the shift control inhibiting unit sets the target input rotational speed to a high speed when it is determined that the request for acceleration that is equal to or larger than the predetermined value is made.

9. The continuously variable transmission shift control system according to claim 1, wherein the shift control inhibiting unit inhibits shift control for reducing the target input rotational speed for a predetermined time after the request for acceleration that has been equal to or larger than the predetermined value becomes smaller than the predetermined value.

10. The continuously variable transmission shift control system according to claim 9, wherein the predetermined time is within a range of 3 to 5 seconds.

11. The continuously variable transmission shift control system according to claim 9, wherein the shift control inhibiting unit cancels inhibition of shift control for reducing the target input rotational speed, when it is determined that the actual input rotational speed reaches the upper limit of the target input rotational speed after a lapse of the predetermined time.

12. The continuously variable transmission shift control system according to claim 9, wherein the shift control inhibiting unit calculates an amount of correction of the target input rotational speed after a lapse of the predetermined time, based on a shift map which contains the information of indicating relationships between a vehicle speed and the target input rotational speed with respect to a plurality of accelerator operation amount accelerator operation amount, and reduces the target input rotational speed by the amount of correction.

13. The continuously variable transmission shift control system according to claim 1, wherein the shift control inhibiting unit controls a gear ratio of the continuously variable transmission so as to increase the target input rotational speed in proportion to a vehicle speed.

14. The continuously variable transmission shift control system according to claim 1, wherein the acceleration request determining unit includes a kick-down switch is turned on when an accelerator operation amount is reached to a predetermined amount, and determines that the request for acceleration that is equal to or larger than the predetermined value is made when the kick-down switch is turned on.

15. A continuously variable transmission shift control method, comprising:
setting a target input rotational speed of a continuously variable transmission connected to an internal combustion engine, based on operating conditions of a vehicle;
performing control so as to make an actual input rotational speed of the continuously variable transmission equal to the target input rotational speed;
performing shift control so as to reduce the target input rotational speed when the actual input rotational speed reaches an upper limit of the target input rotational speed;
determining whether a request for acceleration that is equal to or larger than a predetermined value is made; and
inhibiting shift control for reducing the target input rotational speed even when the actual input rotational speed reaches the upper limit of the target input rotational speed, if it is determined that the request for acceleration that is equal to or larger than the predetermined value is made.

16. The continuously variable transmission shift control method according to claim 15 further comprising:
setting the target input rotational speed again based on the operating conditions of the vehicle when the request for acceleration that has been equal to or larger than the predetermined value becomes smaller than the predetermined value;
inhibiting shift control for reducing the target input rotational speed for a predetermined time after the request for acceleration that has been equal to or larger than the predetermined value becomes smaller than the predetermined value;
determining whether the actual input rotational speed reaches the upper limit of the target input rotational speed after a lapse of the predetermined time;
calculating an amount of correction of the target input rotational speed based on the operating conditions of the vehicle when it is determined that the actual input rotational speed reaches the upper limit of the target input rotational speed; and
reducing the target input rotational speed by the amount of correction.
